(19) United States
(12) Patent Application Publication
(10) Pub. No.: US 2010/0317398 A1
(43) Pub. Date: Dec. 16, 2010

(54) CAMERA SYSTEM AND METHOD FOR FLASH-BASED PHOTOGRAPHY

(76) Inventor: Ola Thorn, Maimo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/481,642

(22) Filed: Jun. 10, 2009

(51) Int. Cl. G06K 9/46; H04N 5/222; H04M 1/00

(52) U.S. Cl. 455/556.1; 348/371; 348/333.11; 382/190; 348/E05.029; 348/E05.047

(57) ABSTRACT

A flash-related function involves flash range indication to indicate when one or more subjects are in the range of a flash and indicate when one or more subjects are not in the range of the flash. The indications may be made to a user on an electronic viewfinder during photograph composition to assist the user in composing a quality photograph. Another flash-related function involves automatically turning on a fill flash when a potential subject is backlight.

### TECHNICAL FIELD OF THE INVENTION

The technology of the present disclosure relates generally to photography and, more particularly, to camera systems and methods for improving image quality with the use of flash-related functionality.

### BACKGROUND

Photographing a scene sometimes may be improved with the use of a flash. For instance, in low light situations, the appearance of persons in a photograph may be improved when the photograph is taken during the firing of a flash. But the user may not appreciate when one or more subjects are in the range of the flash. As another example, when a subject is backlight, the appearance of the subject in a photograph may be improved when the photograph is taken during the firing of a flash. But the backlighting may indicate to automated camera setting functionality that a flash is not needed and/or to use a fast shutter speed. The result is that the subject may appear unintentionally dark in the photograph.

### SUMMARY

To enhance taking photographs in various illumination situations, the present disclosure describes an improved camera systems and methods that include flash-related functionality. One flash-related function involves flash range indication to indicate when one or more subjects are in the range of a flash and indicate when one or more subjects are not in the range of a flash. The indications may be made to a user on an electronic viewfinder during photograph composition to assist the user in composing a quality photograph. In one embodiment, the range of plural potential subjects in the camera's field of view is determined. These ranges are individually compared to an effective range of the camera's flash. Subjects within the flash's effective range may be marked in a first manner on the camera's electronic viewfinder and subjects located beyond the flash's effective range may be marked in a second manner on the camera's electronic viewfinder.

Another flash-related function involves automatically turning on a fill flash when a potential subject is backlight. In one embodiment, if illumination conditions indicate that a flash is not needed, a scan for subjects may be made. Scanning for subjects may involve, for example, face detection, hand detection, silhouette detection, human gait detection, animal detection, or the like. If a subject is detected, a fill flash may be used during the taking of a photograph. In addition, other settings may be adjusted, such as aperture and/or shutter speed.

According to one aspect of the disclosure, a camera assembly includes a light source that provides supplemental illumination to a scene; a sensor that converts light from the scene into corresponding image data; an electronic viewfinder that displays a preview image of the scene; and a controller configured to analyze image data used to generate the preview image and detect the presence of plural subjects in the scene, and for each detected subject that is not in a range of the light source, cause display of an indicator that the subject is not in the range of the light source in conjunction with the preview image on the electronic viewfinder.

According to one embodiment of the camera assembly, for each detected subject that is in range of the light source, the controller is further configured to cause display of an indicator that the subject is in range of the light source in conjunction with the preview image on the electronic viewfinder.

According to one embodiment of the camera assembly, the indicator is a frame around the corresponding detected subject.

According to one embodiment, the camera assembly further includes a distance meter configured to measure distance between each detected face and the camera assembly.

According to one embodiment of the camera assembly, the subjects are faces of persons.

According to one embodiment of the camera assembly, distance between each detected face and the camera assembly is approximated by analyzing characteristics of the face and comparing an area of the scene that the face occupies with a predetermined value for persons of similar characteristics, and after compensating for zoom, determining that the face is out of range if the area occupied by the face is smaller than the predetermined value.

According to one embodiment of the camera assembly, the camera assembly is part of a mobile telephone.

According to one embodiment of the camera assembly, the light source is a flash.

According to another aspect of the disclosure, a camera assembly includes a light source that provides supplemental illumination to a scene; a sensor that converts light from the scene into corresponding image data; and a controller configured to a) analyze illumination data to detect presence of illumination conditions that indicate that no supplemental light source is needed for photograph image capture; b) analyze image data from a sensor to detect the presence of a subject and determine that the subject is within a range of the light source; c) analyze the image data from the sensor to detect that a tonal range of the subject is outside predetermined limits; and d) when a), b) and c) are satisfied, activate the light source during capturing of image data in response to user command.

According to one embodiment of the camera assembly, illumination conditions that satisfy a) include the presence of backlighting of the subject.

According to one embodiment of the camera assembly, the subject is detected by at least one of face detection, hand detection, human gait detection or silhouette detection.

According to one embodiment of the camera assembly, the camera assembly is part of a mobile telephone.

According to another aspect of the disclosure a method of camera assembly operation includes analyzing image data output by a sensor and used to generate a preview image for an electronic viewfinder to detect the presence of plural subjects in the scene; and for each detected subject that is not in a range of a supplemental light source, displaying an indicator that the subject is not in the range of the supplemental light source in conjunction with the preview image on the electronic viewfinder.

According to one embodiment, the method further includes, for each detected subject that is in range of the supplemental light source, displaying of an indicator that the subject is in range of the supplemental light source in conjunction with the preview image on the electronic viewfinder.

According to one embodiment of the method, the indicator is a frame around the corresponding detected subject.

According to one embodiment, the method further includes measuring distance between each detected subject and the camera assembly with a distance meter.

According to one embodiment of the method, the subjects are faces of persons.

According to one embodiment of the method, distance between each detected face and the camera assembly is approximated by analyzing characteristics of the face and comparing an area of the scene that the face occupies with a predetermined value for persons of similar characteristics, and after compensating for zoom, determining that the face is out of range if the area occupied by the face is smaller than the predetermined value.

According to one embodiment of the method, the camera assembly is part of a mobile telephone.

According to one embodiment of the method, the supplemental light source is a flash.

According to another aspect of the disclosure, a method of camera assembly operation includes a) analyzing illumination data to detect presence of illumination conditions that indicate that no supplemental light source is needed for photograph image capture; b) analyzing image data from a sensor to detect the presence of a subject and determining that the subject is within a range of a supplemental light source of the camera assembly; c) analyzing the image data from the sensor to detect that a tonal range of the subject is outside predetermined limits; and d) when a), b) and c) are satisfied, activating the supplemental light source during capturing of image data in response to user command.

According to one embodiment of the method, illumination conditions that satisfy a) include the presence of backlighting of the subject.

According to one embodiment of the method, the subject is detected by at least one of face detection, hand detection, human gait detection or silhouette detection.

According to one embodiment of the method, the camera assembly is part of a mobile telephone.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIGS. 1 and 2 are respectively a front view and a rear view of an exemplary electronic device that includes a representative camera assembly;

FIG. 3 is a schematic block diagram of the electronic device of FIGS. 1 and 2 as part of a communications system in which the electronic device may operate;

FIG. 4 is a flow diagram of an exemplary technique for indicating flash range;

FIG. 5 is an exemplary representation of a scene in which flash range is indicated using an electronic viewfinder under the technique of FIG. 4;

FIG. 6 is a flow diagram of an exemplary technique for fill flash operation; and

FIGS. 7 and 8 are exemplary representations of conditions under which a fill flash may be employed using the technique of FIG. 6.

### DETAILED DESCRIPTION OF EMBODIMENTS

Embodiments will now be described with reference to the drawings, wherein like reference numerals are used to refer to like elements throughout. It will be understood that the figures are not necessarily to scale.

Described below in conjunction with the appended figures are various embodiments of improved camera systems and methods of camera operation. In the illustrated embodiments, the camera system is embodied as a digital camera assembly that is made part of a mobile telephone. It will be appreciated that the disclosed camera technology may be applied to other operational contexts such as, but not limited to, a dedicated camera or another type of electronic device that has a camera. Examples of these other devices include, but are not limited to a video camera, a navigation device (commonly referred to as a “GPS” or “GPS device”), a personal digital assistant (PDA), a media player (e.g., an MP3 player), a gaming device, a “web” camera, a computer (including a laptop, an “ultra-mobile PC” or other type of computer), and an accessory for another electronic device. The camera assembly may be used to capture image data in the form of still images, also referred to as pictures and photographs, but it will be understood that the camera assembly may be capable of capturing video images in addition to still images. The camera operation techniques are described in the exemplary context of still photography, but it will be appreciated that the techniques may be used in connection with videography.

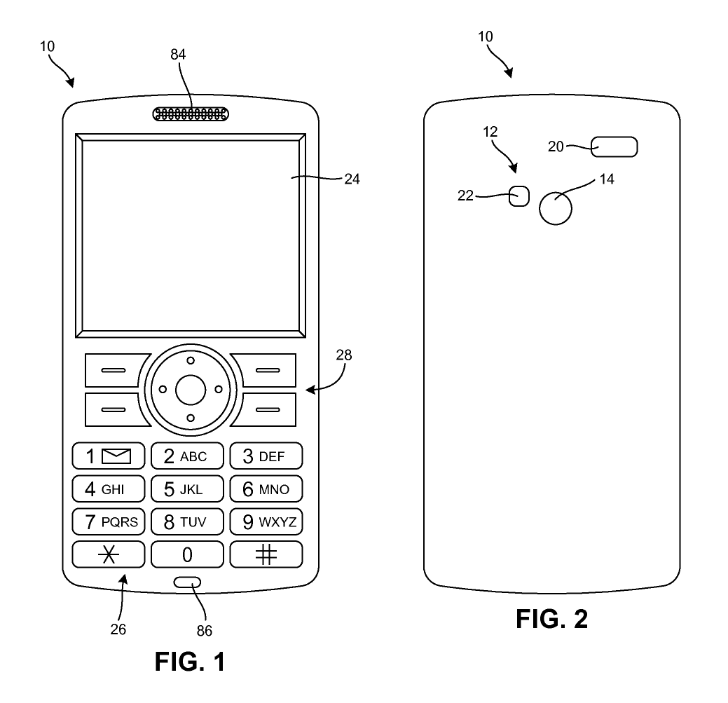

Referring initially to FIGS. 1 and 2, an electronic device 10 is shown. The illustrated electronic device 10 is a mobile telephone. The electronic device 10 includes a camera assembly 12 for taking digital still pictures and/or digital video clips. It is emphasized that the electronic device 10 need not be a mobile telephone, but could be a dedicated camera or some other device as indicated above.

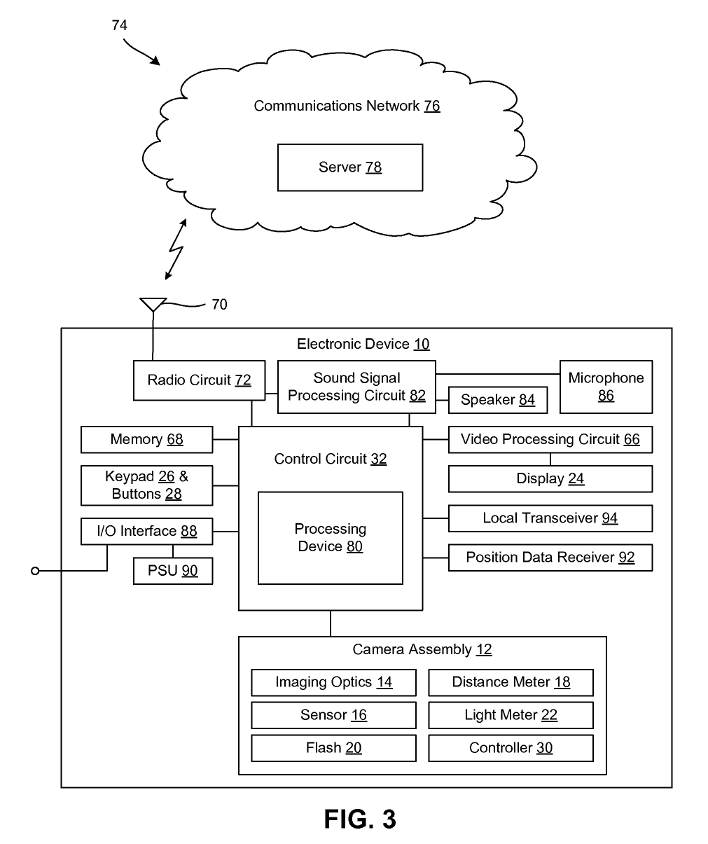

With additional reference to FIG. 3, the camera assembly 12 may be arranged as a typical camera assembly that includes imaging optics 14 to focus light from a scene within the field of view of the camera assembly 12 onto a sensor 16. The sensor 16 converts the incident light into image data. The imaging optics 14 may include a lens assembly and components that that supplement the lens assembly, such as a protective window, a filter, a prism, and/or a mirror. To adjust the focus of the camera assembly 12, a focusing assembly that includes focusing mechanics and/or focusing control electronics may be present in conjunction with the imaging optics 14. A zooming assembly also may be present to optically change the magnification of captured images.

Other camera assembly 12 components may include a distance meter 18 (also referred to as a rangefinder), a supplemental illumination source (e.g., a flash 20), a light meter 22, a display 24 for functioning as an electronic viewfinder and as part of an interactive user interface, a keypad 26 and/or buttons 28 for accepting user inputs, an optical viewfinder (not shown), and any other components commonly associated with cameras. One of the buttons 28 may be a shutter key that the user may depress to command the taking of a photograph. Alternatively, the shutter key and other user input functionality may be implemented using touch screen technology associated with the display 24.

Another component of the camera assembly 12 may be an electronic controller 30 that controls operation of the camera assembly 12. The controller may be embodied, for example, as a processor that executes logical instructions that are stored by an associated memory, as firmware, as an arrangement of dedicated circuit components or as a combination of these embodiments. Thus, the method of operating the camera assembly 12 may be physically embodied as executable code (e.g., software) that is stored on a computer or machine readable medium, or may be physically embodied as part of an electrical circuit. In another embodiment, the functions of the electronic controller 30 may be carried out by a control circuit 32 that is responsible for overall operation of the electronic device 10. In this case, the controller 30 may be omitted. In another embodiment, camera assembly 12 control functions may be distributed between the controller 30 and the control circuit 32.

The sensor 16 may capture data at a predetermined frame rate to generate a preview video signal that is displayed on the display 24 for operation as an electronic viewfinder to assist the user compose photographs.

Certain objects from the scene may be classified as subjects and the controller 30 may be configured to ascertain the presence of subjects in the field of view of the camera assembly 12. In one embodiment, subjects are persons. The identification of persons as subjects may be made by one or more techniques including, by not limited to, face detection, hand detection, silhouette detection, and human gait detection (e.g., detecting an object is human by recognizing a movement that is attributable to a person). In other embodiments, subjects may include other objects in addition to persons. Other objects may include, for example, animals, flowers, cars, text, and so forth. Subjects may be identified by processing of image data output by the sensor. Non-human subjects may be identified using object and/or scene theme recognition techniques. Text may be recognized using, for example, optical character recognition (OCR), and may be useful to identify signs that are present in the scene.

Subject identification processing may be made even in low illumination conditions using infrared (or “see-in-the-dark”) image data capturing and processing. In addition, facial recognition may be used to determine the identity of persons in the scene and/or identify characteristics of persons in the scene. Identifiable characteristics may include, for example, a subject's gender, a subject's approximate age, and so forth.

The distance meter 18 may determine a distance between subjects in the scene and the camera assembly 12. In other embodiments, the distance between subject in the scene and the camera assembly 12 may be approximated by the controller 30 without the use of a distance meter that measures actual distance. For instance, face detection may be used to identify subjects in the scene. Then, the size of each face may be determined, such as by calculating the area of the scene that the face consumes. Using average face size information at the limit of the range of the flash, and compensating for an amount of zoom, a determination of the approximate distance between the subject and the camera assembly 12 may be made. For instance, if the determined face size is larger than average, the face may be in the range of the flash. But if the determined face size is smaller than average, the face may not be in range of the flash. More accurate approximation may be made if the subject's identity, gender, age and/or other characteristic is determined. In this case, the face size information to which the detected face size is compared may be selected with more specificity for more accurate range determination. For example, if a determination is made that the subject is an adult female, the detected face size may be compared to an appropriate adult female control value. As another example, if a determination is made that the subject is a male child, a male child value may be used.

The light meter 22 may be used to evaluate illumination conditions in the scene. Data from the light meter 22 may be analyzed by the controller 30 to adjust settings of the camera assembly 12, such as flash operation (on or off), flash power (if variable), aperture size, shutter speed, etc.

In the following description of exemplary camera operations, the flash 20 is the supplemental illumination source. It will be understood that the supplemental illumination source may be another type of source, such as a lamp (e.g., for supporting videography), a photo lamp (e.g., a non-flash LED), or other illumination device. Also, the display 24 may be used as a light source. For instance, if the camera assembly 12 is a webcam or a camera for video telephony, the display 24 may be driven to display a large amount of white or to produce other light output so as to assist in illuminating the user. In addition, the exemplary camera operations may be used in conjunction with red-eye reduction techniques where the scene is illuminated prior to photo imaging to reduce pupil size of any human subjects.

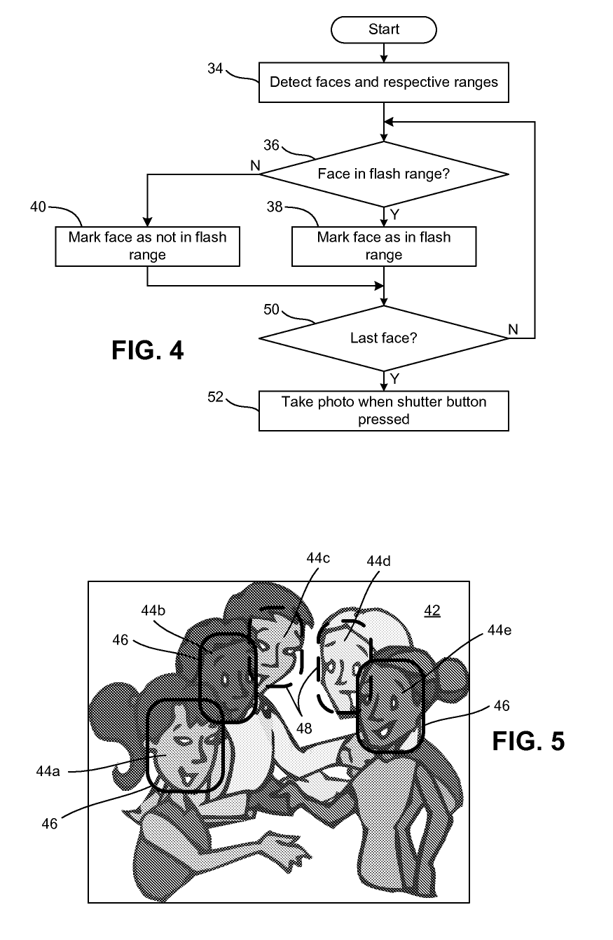

With additional reference to FIG. 4, illustrated is a flow diagram of an exemplary method of operating a camera assembly 12 while indicating flash range to a user of the camera assembly 12. In this operational mode, face detection is used to discern distances of human targets and/or other types of subjects. For purposes of the description, the following describes indicating whether persons are within range of a flash. But the techniques equally apply to other types of subjects. Using the distance values, facial targets that are in range of the flash 20 may be graphically indicated on the electronic viewfinder 24 and/or facial targets that are not in range of the flash 20 may be graphically indicated on the electronic viewfinder 24. The graphic indications provide the use with feedback with respect to which faces may be exposed with the assistance of the flash 20 if a picture were to be taken, thereby assisting the user in composing the photograph before the photographic is taken. The method depicted by FIG. 4 may be carried out only when illumination conditions or manual settings indicate that the flash 20 is to be operated. In other situations, the method need not be carried out.

The exemplary method may be carried out by executing code stored by the electronic device 10, for example. Thus, the flow chart of FIG. 4 may be thought of as depicting steps of a method carried out by the electronic device 10.

Variations to the illustrated method are possible and, therefore, the illustrated embodiment should not be considered the only manner of carrying out the techniques that are disclosed in this document. Also, while FIG. 4 shows a specific order of executing functional logic blocks, the order of executing the blocks may be changed relative to the order shown. In addition, two or more blocks shown in succession may be executed concurrently or with partial concurrence. Certain blocks also may be omitted.

The logical flow may begin in block 34 where, during viewfinder operation, faces in the field of view of the camera assembly 12 are detected. The distance between each face and the camera assembly 12 also is determined. Next, in block 36, a determination may be made as to whether a detected face is within the effective range of the flash 20. The range of the flash 20 may be predetermined. For instance, the range of the flash 20 may be based on known characteristics of the model of the flash that is made part of the camera assembly 12.

If a positive determination is made, the logical flow may proceed to block 38 where the face is graphically marked on the preview image of the electronic viewfinder 24 as being in range of the flash 20. If a negative determination is made, the logical flow may proceed to block 40 where the face is graphically marked on the preview image of the electronic viewfinder 24 as not being in range of the flash 20.

With additional reference to FIG. 5, illustrated is an exemplary preview image 42 that is displayed on the electronic viewfinder 24. As will be appreciated, the illustrated preview image 42 is frozen at a moment in time, but will typically be displayed in dynamic fashion to be updated with the corresponding scene. The determination of faces that are in and/or out of flash range, together with the graphical indications thereof, also may be dynamically updated.

In the illustrated example, the preview image 42 is of a group of five persons where five corresponding faces 44a through 44e have been detected. Exemplary faces 44a, 44b and 44e are closer to the camera assembly 12 than exemplary faces 44c and 44d, which appear more in the background of the scene. For purposes of the example, it will be assumed that faces 44a, 44b and 44e are in range of the flash 20 and that faces 44c and 44d are not in range of the flash 20.

Graphically marking a face as being in range or out of range of the flash 20 may be made in any suitable manner. In the illustrated example, a solid frame 46 (e.g., a frame drawn with a solid line) is placed around each face that is in range of the flash 20 and a dashed frame 48 (e.g., a frame drawn with a broken line) is placed around each face that is not in range of the flash 20. As another example, all detect faces may be framed with a solid line, but where faces in range of the flash 20 receive a frame having a first color (e.g., green) and faces not in range of the flash 20 receive a frame having a second color (e.g., red). The illustrated frames are generally rectangular. It will be appreciated that other shapes (e.g., ovals, circles, polygons, etc.) may be used. Also, marking may be made using other techniques. For example, semi-transparent color areas may be positioned over the subjects, arrows may be used, or text may be used. As another example, a lighting bolt icon representing flash operation may be displayed in connection with faces that are in range of the flash 20 and an icon with a lighting bolt that has been crossed-through may be displayed in connection with faces that are not in range of the flash 20.

Following block 38 or block 40, the logical flow may proceed to block 50 where a determination is made as to whether the last detected face has been analyzed. If a negative determination is made, the logical flow may return to block 36 to analyze another detected face. If a positive determined is made in block 50, the logical flow may proceed to block 52. In block 52, a photograph may be captured and stored in memory in response to user action, such as depression of a shutter release button.

The foregoing flash range indication technique provides the photographer with feedback as to which subjects may appear well exposed due to the flash 20 and which subjects may appear dark because they are too far away from the camera assembly 12 to be effectively illuminated with the flash 20. Most users do not have a good idea of the effective range of the flash 20. Therefore, the indication technique may assist the user compose desirable photographs by repositioning the camera assembly 12 relative to the scene and/or repositioning the subjects within the scene. The disclosed techniques have advantage over conventional photography. For example, the user may be able to better predict when a “good” photo will be taken versus when a “bad” photo will be taken that has subjects that are not well exposed. This may be especially true when zoom is used and the field of view of the camera is concentrated on a distant scene where flash operation will not have much of an effect in providing supplemental illumination.

In one embodiment, the camera assembly 12 may be further configured to detect if a subject is positioned behind another subject or other object in such a manner that the presence of the item in the foreground may cast a shadow on the subject during firing of the flash. Subjects that may be fully or partially exposed to a cast shadow may be marked on the electronic viewfinder as being out of range of the flash (e.g., in accordance with block 40) or with another graphical indicator that conveys the possibility of the occurrence of a cast shadow on the subject during firing of the flash.

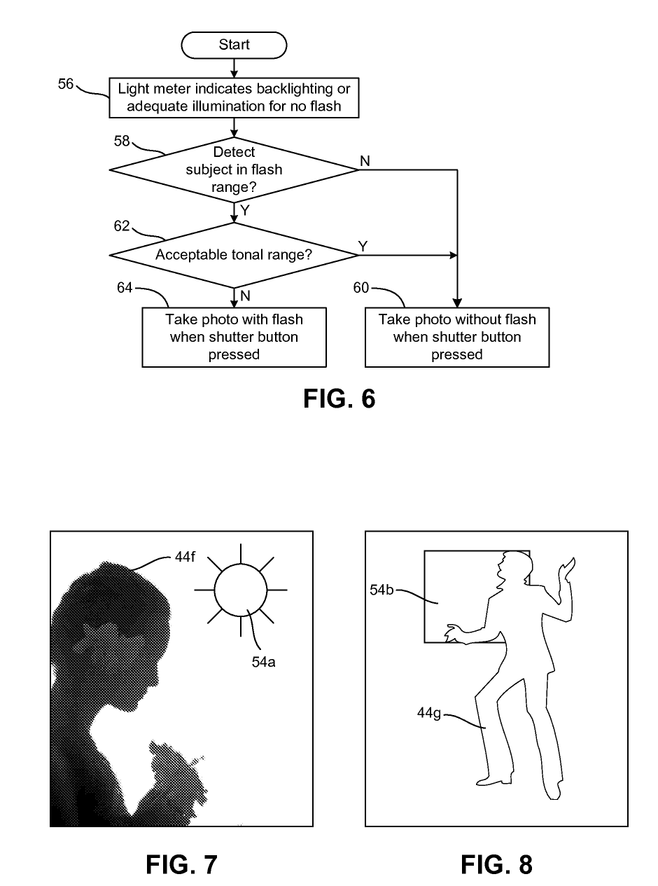

With additional reference to FIG. 6, illustrated is a flow diagram of an exemplary method of operating a camera assembly 12 in a manner to improve exposure of one or more subjects that are backlit. In this operational mode, one or more of the above-described techniques for identifying a human subject (or part of a person) and/or other types of subjects may be employed.

Additional reference is made to FIGS. 7 and 8 for exemplary situations where human subjects are backlit. In the example of FIG. 7, face and/or silhouette detection may be able to identify a human subject 44f that is backlit by a light source 54a. In the illustrated embodiment, the light source 54a is the sun. In the example of FIG. 8, human gait detection and/or face detection may be able to identify a human subject 44g that is engaged in dance and backlit by a light source 54b. In the illustrated embodiment, the light source 54b is light coming through a window. Another typical backlight source is a lamp. While these examples relate to human subjects, the disclosed techniques are equally applicable to non-human subjects.

The exemplary method may be carried out by executing code stored by the electronic device 10, for example. Thus, the flow chart of FIG. 6 may be thought of as depicting steps of a method carried out by the electronic device 10.

Variations to the illustrated method are possible and, therefore, the illustrated embodiment should not be considered the only manner of carrying out the techniques that are disclosed in this document. Also, while FIG. 6 shows a specific order of executing functional logic blocks, the order of executing the blocks may be changed relative to the order shown. In addition, two or more blocks shown in succession may be executed concurrently or with partial concurrence. Certain blocks also may be omitted.

The logical flow may begin in block 56 where light metering of the scene indicates that there is a backlighting condition, such as by detecting a region of relatively high illumination level. In another embodiment, directly detecting a backlighting condition need not be made. Rather, the light metering of the scene may indicate that there is sufficient light to not use the flash.

Next, in block 58, a determination may be made as to whether a subject is detected in the scene using any one or more of the foregoing subject-detection techniques. Also, if a subject is detected, the distance between the subject and the camera assembly 12 may be determined using any one or more of the foregoing distance-determining techniques. A further determination may be made as to whether the subject is within the effective range of the flash 20. If a negative determination is made in block 58 (e.g., no subject is detected or, if a subject is detected, the subject is outside the range of the flash 20), then the logical flow may proceed to block 60. In block 60 a photograph may be captured and stored in memory in response to user action, such as depression of a shutter release button. In one embodiment, no flash may be used during the capture of the photograph in block 60. However, shutter speed and/or aperture may be adjusted based on the lighting conditions.

If a positive determination is made in block 58 (e.g., a subject is present within the effective range of the flash 20), the logical flow may proceed to block 62. In block 62 a determination may be made as to whether the subject has an acceptable tonal range. In one embodiment, acceptable tonal range may be found if color presence is found above a predetermined threshold (e.g., below the threshold indicating a dark subject that is silhouetted by the light source 54). If the subject has acceptable tonal range, the backlighting may not have a significant negative effect on the imaging of the subject. Therefore, if a positive determination is made in block 62, the logical flow may proceed to block 60. In one embodiment, the functionality of block 62 may be reserved for human subjects and need not be carried out for non-human subjects. In this embodiment, tonal range acceptability may be determined by detecting the presence of flash tones in the area of the subject in an amount that exceeds a predetermined threshold.

If a negative determination is made in block 62, the logical flow may proceed to block 64. In block 64 a photograph may be captured and stored in memory in response to user action, such as depression of a shutter release button. During the taking of the photograph in block 64, the flash 20 may be fired to serve as a fill flash for the subject. Also, shutter speed and/or aperture may be adjusted based on the lighting conditions and the use of the flash 20.

In the technique described in connection with FIG. 6, the fill flash is fired under appropriate conditions without user action. In that sense, the fill flash is employed automatically when conditions indicate that the fill flash will be of value to exposing the subject. If the user is interested in capturing a silhouette of a subject for artistic reasons, the functionality may be turned off. However, in most situations, the functionality will lead to improved photographic results without added action by the user.

As indicated, the illustrated electronic device 10 shown in FIGS. 1 and 2 is a mobile telephone. Features of the electronic device 10, when implemented as a mobile telephone, will be described with additional reference to FIG. 3. The display 24 displays graphical user interfaces, information and content (e.g., images, video and other graphics) to a user to enable the user to utilize the various features of the electronic device 10. The display 24 may be coupled to the control circuit 32 by a video processing circuit 66 that converts video data to a video signal used to drive the display 18. The video processing circuit 66 may include any appropriate buffers, decoders, video data processors and so forth.

The keypad 26 and/or buttons 28 provide for a variety of user input operations. For example, the keypad 26 may include alphanumeric keys for allowing entry of alphanumeric information. Navigation and select keys or a pointing device also may be present. Keys or key-like functionality also may be embodied as a touch screen associated with the display 24.

The electronic device 10 includes communications circuitry that enables the electronic device 10 to establish communication with another device. Communications may include voice calls, video calls, data transfers, and the like. Communications may occur over a cellular circuit-switched network or over a packet-switched network (e.g., a network compatible with IEEE 802.11, which is commonly referred to as WiFi, or a network compatible with IEEE 802.16, which is commonly referred to as WiMAX). Data transfers may include, but are not limited to, receiving streaming content, receiving data feeds, downloading and/or uploading data (including Internet content), receiving or sending messages (e.g., text messages, instant messages, electronic mail messages, multimedia messages), and so forth. This data may be processed by the electronic device 10, including storing the data in a memory 68, executing applications to allow user interaction with the data, displaying video and/or image content associated with the data, outputting audio sounds associated with the data, and so forth.

In the exemplary embodiment, the communications circuitry may include an antenna 70 coupled to a radio circuit 72. The radio circuit 72 includes a radio frequency transmitter and receiver for transmitting and receiving signals via the antenna 70. The radio circuit 72 may be configured to operate in a mobile communications system 74. Radio circuit 72 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 70 and the radio circuit 72 may represent one or more than one radio transceiver.

The system 74 may include a communications network 76 having a server 78 (or servers) for managing calls placed by and destined to the electronic device 10, transmitting data to and receiving data from the electronic device 10 and carrying out any other support functions. The server 78 communicates with the electronic device 10 via a transmission medium. The transmission medium may be any appropriate device or assembly, including, for example, a communications base station (e.g., a cellular service tower, or “cell” tower), a wireless access point, a satellite, etc. The network 76 may support the communications activity of multiple electronic devices 10 and other types of end user devices. As will be appreciated, the server 78 may be configured as a typical computer system used to carry out server functions and may include a processor configured to execute software containing logical instructions that embody the functions of the server 78 and a memory to store such software. In alternative arrangements, the electronic device 10 may wirelessly communicate directly with another electronic device 10 (e.g., another mobile telephone or a computer) and without an intervening network.

As indicated, the electronic device 10 may include the primary control circuit 32 that is configured to carry out overall control of the functions and operations of the electronic device 10. The control circuit 32 may include a processing device 80, such as a central processing unit (CPU), microcontroller or microprocessor. The processing device 80 executes code stored in a memory (not shown) within the control circuit 32 and/or in a separate memory, such as the memory 68, in order to carry out operation of the electronic device 10. The memory 68 may be, for example, one or more of a buffer, a flash memory, a hard drive, a removable media, a volatile memory, a non-volatile memory, a random access memory (RAM), or other suitable device. In a typical arrangement, the memory 68 may include a non-volatile memory for long term data storage and a volatile memory that functions as system memory for the control circuit 32. The memory 68 may exchange data with the control circuit 32 over a data bus. Accompanying control lines and an address bus between the memory 68 and the control circuit 32 also may be present.

The electronic device 10 further includes a sound signal processing circuit 82 for processing audio signals transmitted by and received from the radio circuit 72. Coupled to the sound processing circuit 82 are a speaker 84 and a microphone 86 that enable a user to listen and speak via the electronic device 10, and hear sounds generated in connection with other functions of the device 10. The sound processing circuit 82 may include any appropriate buffers, decoders, amplifiers and so forth.

The electronic device 10 may further include one or more input/output (I/O) interface(s) 88. The I/O interface(s) 88 may be in the form of typical mobile telephone I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 88 and power to charge a battery of a power supply unit (PSU) 90 within the electronic device 10 may be received over the I/O interface(s) 88. The PSU 90 may supply power to operate the electronic device 10 in the absence of an external power source.

The electronic device 10 also may include various other components. A position data receiver 92, such as a global positioning system (GPS) receiver, may be involved in determining the location of the electronic device 10. A local wireless transceiver 94, such as a Bluetooth chipset, may be used to establish communication with a nearby device, such as an accessory (e.g., a PHF device), another mobile radio terminal, a computer or another device.

Although certain embodiments have been shown and described, it is understood that equivalents and modifications falling within the scope of the appended claims will occur to others who are skilled in the art upon the reading and understanding of this specification.

What is claimed is:

1. A camera assembly, comprising:
a light source that provides supplemental illumination to a scene;
a sensor that converts light from the scene into corresponding image data;
an electronic viewfinder that displays a preview image of the scene; and
a controller configured to analyze image data used to generate the preview image and detect the presence of plural subjects in the scene, and for each detected subject that is not in a range of the light source, cause display of an indicator that the subject is not in the range of the light source in conjunction with the preview image on the electronic viewfinder.

2. The camera assembly of claim 1, wherein, for each detected subject that is in range of the light source, the controller is further configured to cause display of an indicator that the subject is in range of the light source in conjunction with the preview image on the electronic viewfinder.

3. The camera assembly of claim 1, wherein the indicator is a frame around the corresponding detected subject.

4. The camera assembly of claim 1, further comprising a distance meter configured to measure distance between each detected subject and the camera assembly.

5. The camera assembly of claim 1, wherein the subjects are faces of persons.

6. The camera assembly of claim 5, wherein distance between each detected face and the camera assembly is approximated by analyzing characteristics of the face and comparing an area of the scene that the face occupies with a predetermined value for persons of similar characteristics, and after compensating for zoom, determining that the face is out of range if the area occupied by the face is smaller than the predetermined value.

7. The camera assembly of claim 1, wherein the camera assembly is part of a mobile telephone.

8. The camera assembly of claim 1, wherein the light source is a flash.

9. A camera assembly, comprising:
a light source that provides supplemental illumination to a scene;
a sensor that converts light from the scene into corresponding image data; and
a controller configured to:
a) analyze illumination data to detect presence of illumination conditions that indicate that no supplemental light source is needed for photograph image capture;
b) analyze image data from a sensor to detect the presence of a subject and determine that the subject is within a range of the light source;
c) analyze the image data from the sensor to detect that a tonal range of the subject is outside predetermined limits; and
d) when a), b) and c) are satisfied, activate the light source during capturing of image data in response to user command.

10. The camera assembly of claim 9, wherein illumination conditions that satisfy a) include the presence of backlighting of the subject.

11. The camera assembly of claim 9, wherein the subject is detected by at least one of face detection, hand detection, human gait detection or silhouette detection.

12. The camera assembly of claim 9, wherein the camera assembly is part of a mobile telephone.

13. A method of camera assembly operation, comprising:
analyzing image data output by a sensor and used to generate a preview image for an electronic viewfinder to detect the presence of plural subjects in the scene; and
for each detected subject that is not in a range of a supplemental light source, displaying an indicator that the subject is not in the range of the supplemental light source in conjunction with the preview image on the electronic viewfinder.

14. The method of claim 13, further comprising, for each detected subject that is in range of the supplemental light source, displaying of an indicator that the subject is in range of the supplemental light source in conjunction with the preview image on the electronic viewfinder.

15. The method of claim 13, wherein the indicator is a frame around the corresponding detected subject.

16. The method of claim 13, further comprising measuring distance between each detected subject and the camera assembly with a distance meter.

17. The method of claim 13, wherein the subjects are faces of persons.

18. The method of claim 17, wherein distance between each detected face and the camera assembly is approximated by analyzing characteristics of the face and comparing an area of the scene that the face occupies with a predetermined value for persons of similar characteristics, and after compensating for zoom, determining that the face is out of range if the area occupied by the face is smaller than the predetermined value.

19. The method of claim 13, wherein the camera assembly is part of a mobile telephone.

20. The method of claim 13, wherein the supplemental light source is a flash.

21. A method of camera assembly operation, comprising:
a) analyzing illumination data to detect presence of illumination conditions that indicate that no supplemental light source is needed for photograph image capture;
b) analyzing image data from a sensor to detect the presence of a subject and determining that the subject is within a range of a supplemental light source of the camera assembly;
c) analyzing the image data from the sensor to detect that a tonal range of the subject is outside predetermined limits; and
d) when a), b) and c) are satisfied, activating the supplemental light source during capturing of image data in response to user command.

22. The method of claim 21, wherein illumination conditions that satisfy a) include the presence of backlighting of the subject.

23. The method of claim 21, wherein the subject is detected by at least one of face detection, hand detection, human gait detection or silhouette detection.

24. The method of claim 21, wherein the camera assembly is part of a mobile telephone.
